(19) United States
(12) Patent Application Publication
(10) Pub. No.: US 2005/0103809 A1
(43) Pub. Date: May 19, 2005

(54) Electrically operated cartridge dispensing appliance

(75) Inventor: Wilhelm A. Keller, Merlischachen (CH)

Correspondence Address: FOLEY AND LARDNER;SUITE 500, 3000 K STREET NW, WASHINGTON, DC, 20007, US

(73) Assignee: Mixpac Systems AG

(21) Appl. No.: 10/984,928

(22) Filed: Nov. 10, 2004

(30) Foreign Application Priority Data
Nov. 13, 2003 (CH) 01954/03

(51) Int. Cl. G01F 11/06; G01F 11/30; G01F 11/36; G01F 11/42; B65D 88/54

(52) U.S. Cl. 222/333

(57) ABSTRACT

The electrically operated cartridge dispensing appliance includes dispensing rams and an electric motor actuating the thrust rods. Through a lever, the electric motor acts upon clamping members which actuate and move the thrust rods. The motor preferably acts upon a disk cam that actuates the lever. The construction of such a driving mechanism is both simple and cost-efficient and space-saving.

### FIELD OF THE INVENTION

The present invention relates to an electrically operated cartridge dispensing appliance including dispensing rams and an electric motor for actuating the thrust rods.

### PRIOR ART

Electrically operated dispensing appliances, particularly for dispensing two-component materials for dental impressions, are e.g. known from EP-A2-1 101 538, where an electric motor actuates lead screws to drive the thrust plates connected thereto and to dispense the two components. Another appliance is disclosed in EP-B-492 413, where a magnet clutch is used for uncoupling the feeding mechanism from a thrust slide that is pulled by chains. Both of the described driving mechanisms have in common that their construction is complicated and therefore expensive or relatively bulky.

Furthermore, EP-B1-0 586 342 or DE-A-3 128 611 disclose an appliance for manual operation where the dispensing rams are actuated by a canted clamping lever. One aim of these embodiments is a most rational force transmission from an actuating lever turning around a fulcrum to linearly advanced rams.

### SUMMARY OF THE INVENTION

On the background of this prior art, the object of the present invention is to provide an electrically operated cartridge dispensing appliance whose mechanism for driving the dispensing rams is simple in construction and space-saving. This is accomplished by an appliance wherein the electric motor acts via a lever upon a clamping lever that actuates and moves the thrust rods.

### BRIEF DESCRIPTION OF THE DRAWINGS

The invention will be explained in more detail hereinafter with reference to drawings of an exemplary embodiment.

FIG. 1 shows a partly sectioned perspective view of the part of the dispensing appliance that is essential to the invention;

FIG. 2 shows the appliance of FIG. 1 in a longitudinal section;

FIG. 3 shows a sectional view of an enlarged detail of the appliance of FIG. 2 in the starting position;

FIG. 4 shows a section according to line IV-IV in FIG. 3;

FIG. 5 shows a sectional view of an enlarged detail of the appliance in the clamping position;

FIG. 6 shows a section according to line VI-VI in FIG. 5;

FIG. 7 shows a sectional view of an enlarged detail of the appliance at the end of the dispensing operation; and

FIG. 8 shows a section according to line VIII-VIII in FIG. 7.

### DETAILED DESCRIPTION OF THE INVENTION

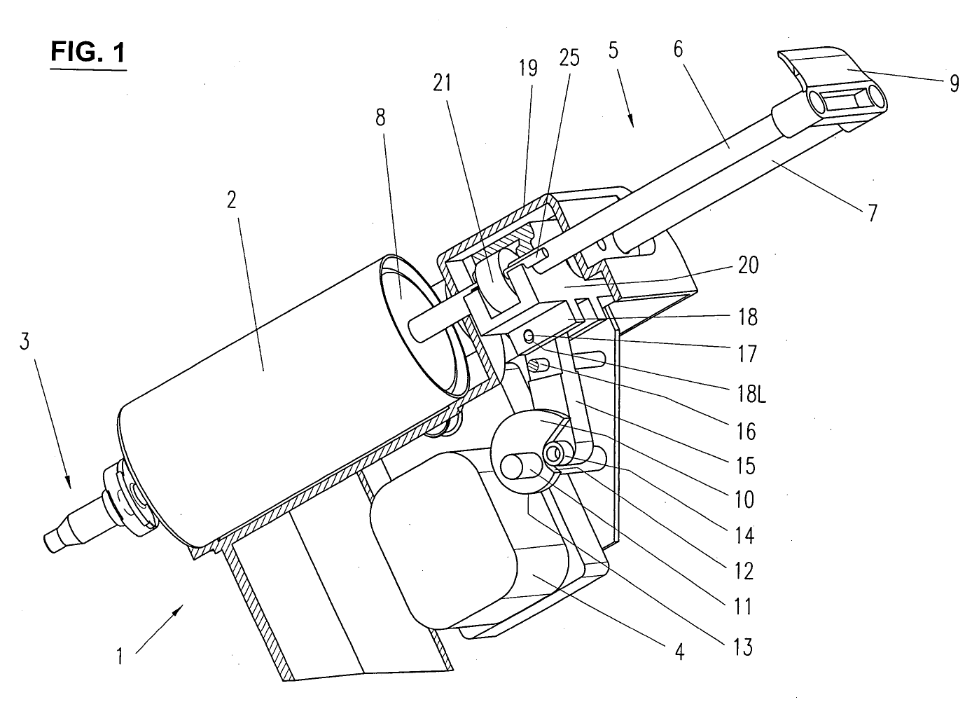

FIG. 1 shows a part of the enclosure 1 of a bench-type appliance as mentioned in the introduction, the enclosure and the cartridge holder being known from the prior art. FIG. 1 further shows one storage container of double cartridge 2 and a dynamic mixer 3 as described in EP-A2-1 106 243, for example. Through a driving mechanism that will be described below, an electric motor 4 actuates a double ram 5 having two thrust rods 6 and 7 and thrust plates 8, thereby supplying the two components contained in the storage containers of the cartridge to the dynamic mixer where they are mixed. The two thrust rods 6 and 7 are connected to each other by a handle 9.

Electric motor 4 actuates a disk cam 10 turning about an axle 11 in the enclosure and essentially comprising two driving surfaces, i.e. a steep clamping ramp 12 and a dispensing surface 13. The disk cam actuates a disk cam roller follower 14 that is fastened to a lever 15 hinged on a pivot 16 supported in the enclosure. Above the pivot, lever 15 is hinged via an axle 17 on a fork 18 of a cuboid driving block 20, axle 17 running in an elongated hole 18L. Driving block 20 is located in a U-shaped portion 19 of the enclosure, and thrust rods 6 and 7 are guided in respective bores in the U-shaped enclosure portion and in driving block 20.

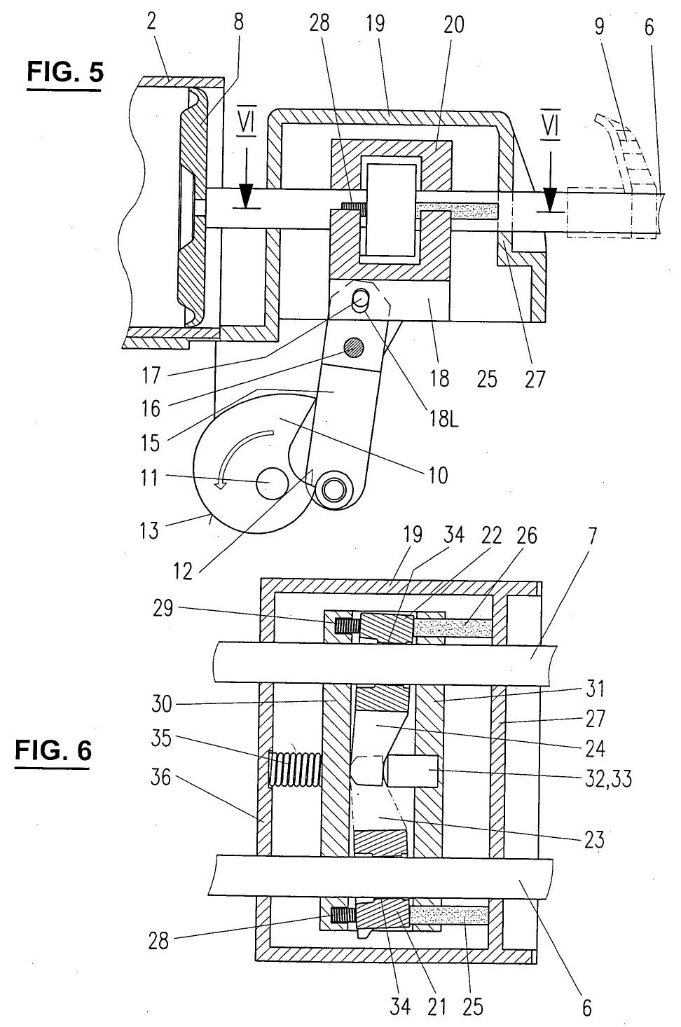

As appears in FIGS. 4, 6, or 8, each thrust rod is surrounded inside cuboid driving block 20 by the clamping portion 21, 22 of an inwardly extending clamping lever 23, 24. A respective aligning pin 25, 26 for each clamping portion passes through driving block rear wall 31, one end of which rests on rear wall 27, with respect to the cartridges, of U-shaped enclosure portion 19, and the other end of which rests on the clamping portion in the starting position in order to restore the non-clamping starting position of the latter after the return stroke. At the front end of the clamping portion, respective compression springs 28, 29 are recessed in front wall 30 of the driving block, which push the clamping portions towards the aligning pins. Opposite each clamping lever, respective canting pins 32, 33 are recessed in rear wall 31 of the driving block.

The two clamping portions 21 and 22 do not fit the thrust rods exactly positively but their bores 34 are slightly larger than the diameter of the thrust rods, thereby allowing the clamping portions to be canted, as appears when comparing FIGS. 4 and 6.

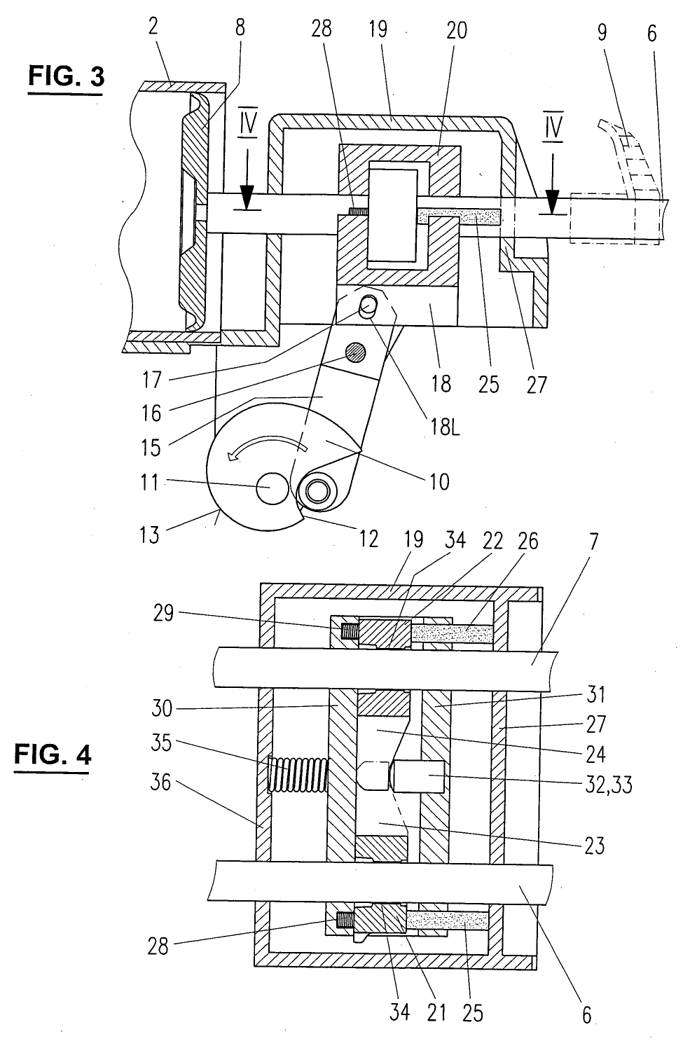

In the starting position according to FIGS. 3 and 4, a symbolically illustrated return spring 35 fastened to front wall 36 of U-shaped enclosure portion 19 pushes driving block 20 in the direction of wall 27, thereby compressing compression springs 28, 29 through aligning pins 25, 26. Clamping portion bores 34 are thus aligned parallel to the thrust rods, thereby allowing a manual actuation of the thrust rods. This arrangement ensures that the clamping levers are engaged as soon as driving block 20 moves in the dispensing direction. Instead of a compression spring between the enclosure and the driving block, a suitable spring arrangement may be provided on lever 15 for pushing the latter forward and thus the driving block backward.

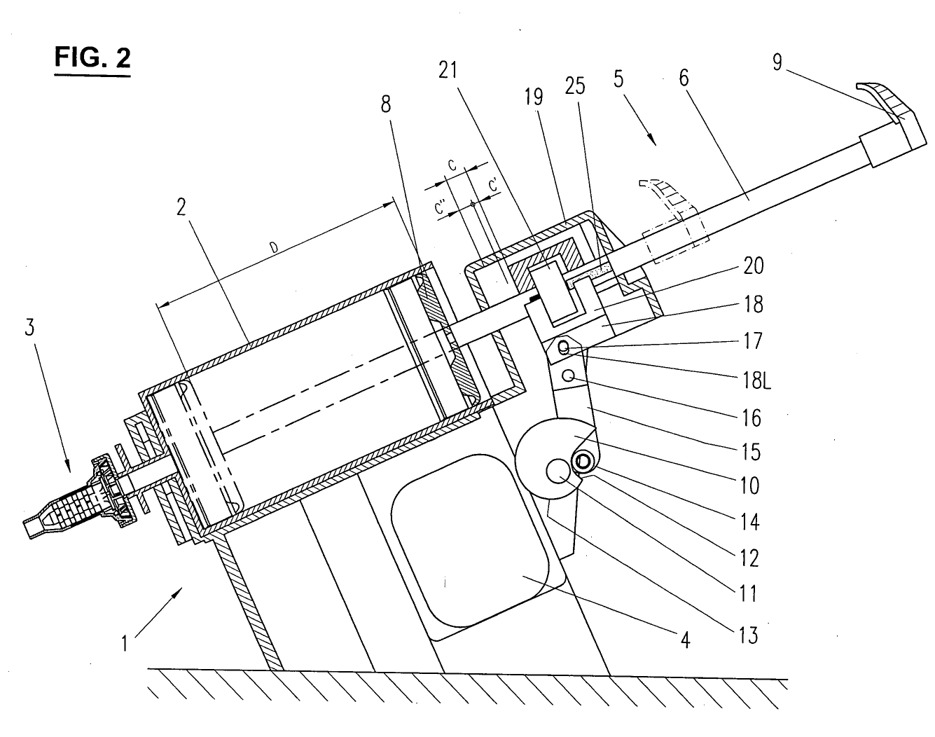

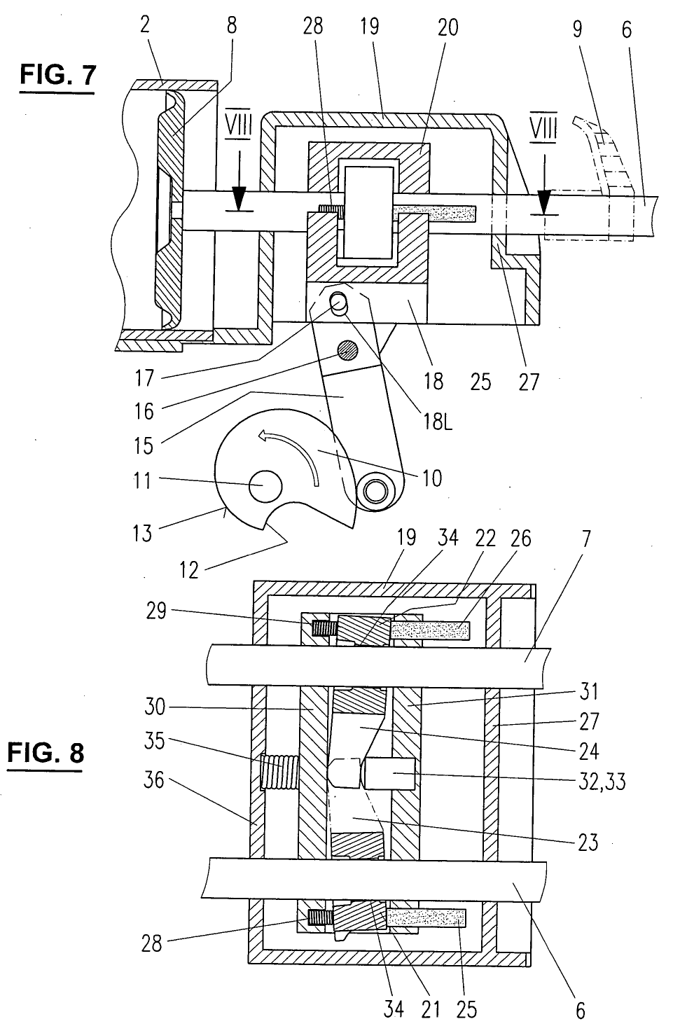

In the position of FIGS. 7 and 8, the disk cam has almost reached the end of the dispensing surface while the clamping portions are still in the clamping position. The driving block and thus the thrust rods have thus attained their full working stroke C″, see FIG. 2.

By actuating a non-represented switch, the motor is started and the disk cam is set into rotation in the direction of the arrow. Starting from the position shown in FIG. 3, the steep clamping ramp 12 of the disk cam actuates disk cam follower roll 13 so that driving block 20 is moved forward in the direction of the cartridge by lever 15. The clamping portions are thereby released and pushed toward the rear wall 31 of the driving block by the compression springs. Through the action of canting pins 32, 33 upon clamping levers 23, 24, the clamping portions are canted and provide a fixed connection between driving block 20 and the thrust rods.

In the position of FIGS. 5 and 6, the clamping portions are maximally canted, and the working stroke begins due to the action of the dispensing surface of the disk cam.

In the position of FIGS. 7 and 8 at the end of the dispensing surface, working stroke C″ is completed and the disk cam has reached the starting and rest position of FIG. 3 after a rotation of 360°. Between the end of the dispensing surface and the beginning of the steep clamping ramp, return spring 35 pushes the driving block back to the starting position. Aligning pins 25, 26 align the clamping portions parallel to the thrust rods, thereby releasing them and allowing their manual retraction.

In FIG. 2 it is shown that during a rotation of 360°, the disk cam first imparts the thrust rods a clamping stroke C′ and then a maximum working stroke C″. However, the dispensing may also be stopped earlier, i.e. after a smaller working stroke. After each partial working stroke, the disk cam is turned back to the starting position where the thrust rods are released by aligning the clamping levers by means of the aligning pins. It is thus possible to retract the thrust rods manually and to remove the cartridge. The entire system stroke D, i.e. the complete dispensing of the cartridge content is achieved by repeated successive working strokes C″ or parts thereof.

1. Electrically operated cartridge dispensing appliance including dispensing rams and an electric motor for actuating the thrust rods, wherein said electric motor acts via a lever upon a clamping lever that actuates and moves the thrust rods.

2. The cartridge dispensing appliance of claim 1, wherein said electric motor drives a disk cam that actuates said lever.

3. The cartridge dispensing appliance of claim 2, wherein said disk cam comprises a steep ramp for achieving the clamping action and a dispensing surface for advancing said thrust rods.

4. The cartridge dispensing appliance of claim 1, wherein said lever is hinged on a cuboid driving block in which said clamping levers are arranged, the front sides of the clamping portions of said clamping levers, with respect to the cartridge, being under the action of compression springs, and the other sides resting on aligning pins that are guided in the rear wall of the block and are supported on the rear wall of the enclosure, and wherein the ends of said clamping levers are under the action of respective canting pins when the disk cam is being driven, thereby canting the clamping portions and moving said thrust rods in the direction of the cartridge.
